(19) United States
(12) Patent Application Publication
(10) Pub. No.: US 2026/0341600 A1
(43) Pub. Date: Oct. 29, 2026

(54) MULTI-LAYER CERAMIC ELECTRONIC COMPONENT AND METHOD OF MANUFACTURING SAME

(71) Applicant: TAIYO YUDEN CO., LTD., Tokyo (JP)

(72) Inventors: Wakaaki MURAI, Tokyo (JP); Satoshi KOBAYASHI, Tokyo (JP); Taiga SAITO, Gunma (JP); Chizuru TADOKORO, Gunma (JP); Seiya SUGAI, Tokyo (JP)

(21) Appl. No.: 19/551,005

(22) Filed: Feb. 26, 2026

(30) Foreign Application Priority Data
Mar. 11, 2025 (JP) 2025-038575

(51) Int. Cl. H01G 4/30; H01G 4/232

(52) U.S. Cl. CPC H01G 4/30; H01G 4/2325

(57) ABSTRACT

A multi-layer ceramic electronic component includes: an element in which multiple internal electrodes and multiple dielectric layers containing a ceramic as a main component are alternately stacked; a metal underlayer provided at an end portion of a surface adjacent to end surfaces of the element, the end portion being closer to one of the end surfaces, the metal underlayer being in contact with one or more of the multiple internal electrodes that are exposed on at least one of the end surfaces; metal portions provided at positions away from the metal underlayer and that are in contact with the surface adjacent to the end surfaces; a glass layer provided between an edge of the metal underlayer and the metal portions and on a side of the metal portions facing away from a corresponding end surface of the end surfaces; and a plating layer provided on the end portion.

### CROSS-REFERENCE TO RELATED APPLICATIONS

This application claims priority to Japanese Patent Application No. 2025-038575, filed Mar. 11, 2025, the entire content of which is incorporated herein by reference.

### BACKGROUND

### 1. Technical Field

The present disclosure relates to a multi-layer ceramic electronic component and a method of manufacturing the same.

### 2. Description of Related Art

An external electrode in a multi-layer ceramic electronic component such as a multi-layer ceramic capacitor is provided with a metal underlayer in contact with an element and a plating layer covering the metal underlayer. It is known that a glass phase is formed between the end portion of an external electrode and the element (e.g., International Publication No. WO 2014/057751, hereinafter “Patent Document 1”).

### SUMMARY

An embodiment of the present disclosure includes a multi-layer ceramic electronic component including: an element in which a plurality of internal electrodes and a plurality of dielectric layers containing a ceramic as a main component are alternately stacked, the element having end surfaces opposite each other; a metal underlayer provided at an end portion of a surface adjacent to the end surfaces, the end portion being closer to one of the end surfaces, the metal underlayer being in contact with one or more of the plurality of internal electrodes that are exposed on at least one of the end surfaces; metal portions provided at positions away from the metal underlayer and that are in contact with the surface adjacent to the end surfaces; a glass layer provided between an edge of the metal underlayer and the metal portions and on a side of the metal portions facing away from a corresponding end surface of the end surfaces; and a plating layer provided on the end portion such that the metal underlayer, the metal portions, and the glass layer are disposed between, and sandwiched by, the plating layer and the element, the plating layer and the metal underlayer forming an external electrode.

An embodiment of the present disclosure includes a method of manufacturing a multi-layer ceramic electronic component, the method including: preparing an element in which a plurality of internal electrodes and a plurality of dielectric layers containing a ceramic as a main component are alternately stacked, the element having end surfaces opposite each other; applying paste containing glass particles containing silicon oxide and metal particles to the end surfaces and an end portion of a surface adjacent to the end surfaces; sintering the paste to form a metal underlayer provided at the end portion and being in contact with one or more of the plurality of internal electrodes that are exposed on at least one of the end surfaces, metal portions provided at positions away from the metal underlayer and that are in contact with the surface adjacent to the end surfaces, and a glass layer provided between an edge of the metal underlayer and the metal portions and on a side of the metal portions facing away from a corresponding end surface of the end surfaces; and forming a plating layer which is provided at the end portion such that the metal underlayer, the metal portions, and the glass layer are disposed between, and sandwiched by, the plating layer and the element, the plating layer and the metal underlayer forming an external electrode.

### BRIEF DESCRIPTION OF THE DRAWINGS

FIG. 1 is a partial sectional perspective view of a multi-layer ceramic capacitor according to a first embodiment;

FIG. 2 is a cross-sectional view taken along the line A-A of FIG. 1;

FIG. 3 is a cross-sectional view taken along the line B-B of FIG. 1;

FIG. 4 is an enlarged view of an end portion of an element according to the first embodiment;

FIG. 5 is a flowchart illustrating a method of manufacturing a multi-layer ceramic capacitor according to the first embodiment;

FIG. 6 is of cross-sectional views illustrating a method of manufacturing the multi-layer ceramic capacitor according to the first embodiment;

FIG. 7 is of cross-sectional views illustrating a method of manufacturing the multi-layer ceramic capacitor according to the first embodiment;

FIG. 8 is an enlarged view of an end portion of an element according to Comparative Embodiment 1;

FIG. 9 is an enlarged view of an end portion of an element according to Comparative Embodiment 2;

FIG. 10 is a schematic plan view of the vicinity of an edge of a metal underlayer at an end portion of an element according to the first embodiment;

FIG. 11 is a schematic plan view of the vicinity of an edge of a metal underlayer at an end portion of an element according to Example 1;

FIG. 12 is a schematic cross-sectional view of the vicinity of the edge of the metal underlayer at the end portion of the element according to Example 1;

FIG. 13 is a schematic cross-sectional view of the vicinity of an edge of a metal underlayer at an end portion of an element according to Comparative Example 2;

FIG. 14 is a graph illustrating the deflection strength in Comparative Example 1, Comparative Example 2, and Example 1;

FIG. 15 is a graph illustrating the leakage current as a function of time in Comparative Example 1; and

FIG. 16 is a graph illustrating the leakage current as a function of time in Example 1.

### DETAILED DESCRIPTION

A plating layer contains a large amount of hydrogen. When the hydrogen in the plating layer diffuses into an element, a dielectric layer is reduced and the characteristics deteriorate.

According to the present disclosure, it is possible to provide a multi-layer ceramic electronic component that suppresses the diffusion of hydrogen into an element, and a method of manufacturing the multi-layer ceramic electronic component.

Embodiments of the present disclosure will be described in detail below, but the present disclosure is not limited thereto. In the present specification and the drawings, components having substantially the same functional configuration are denoted by the same reference numerals, thereby eliminating redundant descriptions.

### First Embodiment

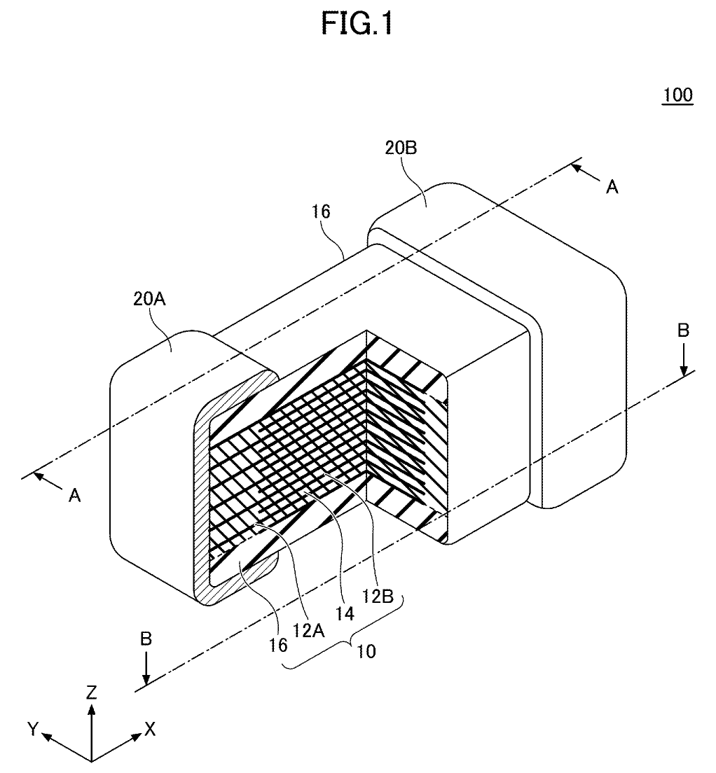

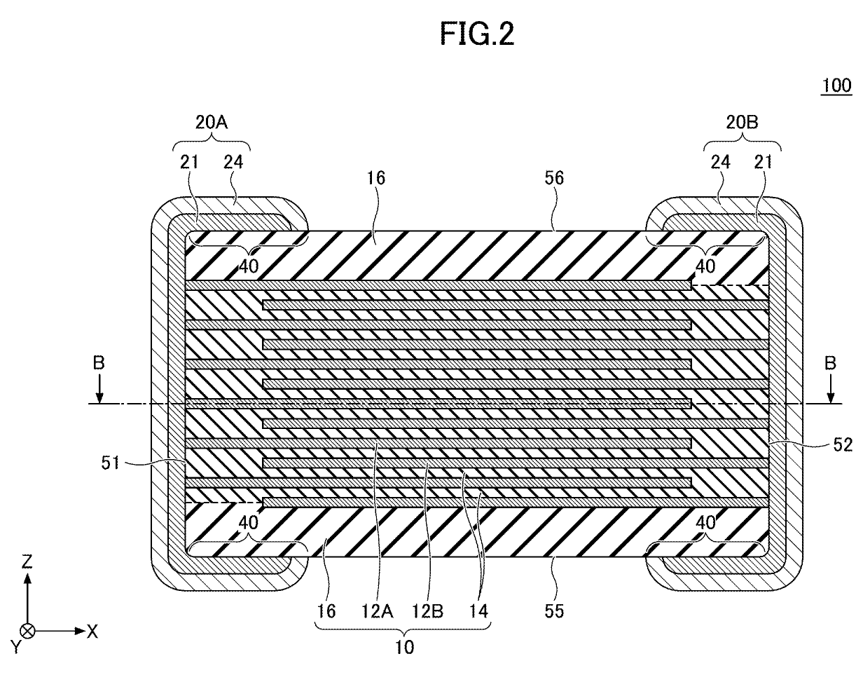

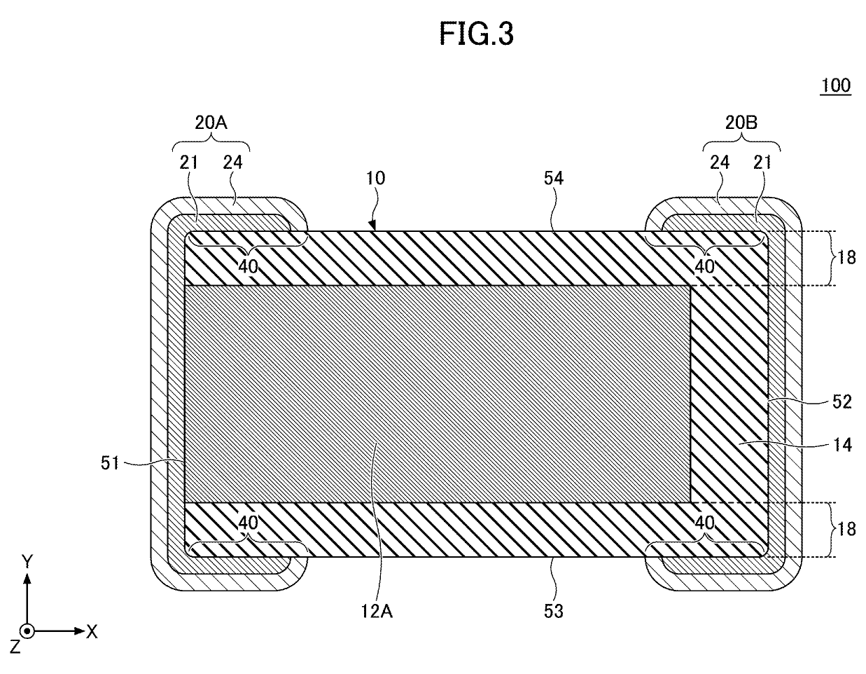

A multi-layer ceramic capacitor will be described as an example of a multi-layer ceramic electronic component. FIG. 1 is a partial sectional perspective view of a multi-layer ceramic capacitor 100 according to the first embodiment. FIG. 2 is a cross-sectional view taken along the line A-A of FIG. 1. FIG. 3 is a cross-sectional view taken along the line B-B of FIG. 1.

In FIGS. 1 through 3, the Z direction (first direction) is a stacking direction in which dielectric layers 14 and internal electrodes 12A and 12B are stacked, and a lower surface 55 and an upper surface 56 of an element 10 opposite each other. The X direction (second direction) is a length direction of the element 10, and a pair of end surfaces 51 and 52 of the element 10 are opposite each other. The Y direction (third direction) is a width direction of the internal electrodes 12A and 12B, and a pair of side surfaces 53 and 54 of the element 10 are opposite each other. The X direction, the Y direction, and the Z direction intersect or are perpendicular to each other.

The multi-layer ceramic capacitor 100 is provided with an element 10 having a substantially rectangular parallelepiped shape, and external electrodes 20A and 20B. The element 10 includes a plurality of dielectric layers 14, a plurality of internal electrodes 12A, a plurality of internal electrodes 12B, and cover dielectric layers 16. The plurality of internal electrodes 12A and the plurality of internal electrodes 12B are alternately stacked, with the dielectric layers 14 provided between adjacent internal electrodes. In the stack in which the dielectric layers 14 and the internal electrodes 12A and 12B are stacked, one outermost layer in the Z direction is an internal electrode 12A and the other outermost layer is an internal electrode 12B, and the lower surface and the upper surface of the stack are covered with the cover dielectric layers 16, respectively. Regions sandwiching the plurality of internal electrodes 12A and 12B in the Y direction are side margin regions 18.

The internal electrodes 12A and 12B are exposed on different end surfaces 51 and 52. The internal electrodes 12A are exposed from the end surface 51 and are not exposed from the end surface 52. The internal electrodes 12B are exposed from the end surface 52 and are not exposed from the end surface 51. In other words, the internal electrodes 12A and 12B are connected to different end surfaces 51 and 52.

The external electrode 20A is in contact with the internal electrodes 12A exposed from the element 10 at the end surface 51. The external electrode 20B is in contact with the internal electrodes 12B exposed from the element 10 at the end surface 52. In addition to the end surface 51, the external electrode 20A covers end portions 40 of the side surfaces 53 and 54, of the lower surface 55, and of the upper surface 56 on the −X side. Herein, the end portions 40 are portions of the side, upper, and lower surfaces that are adjacent to the end surfaces 51 and 52 of the element 10. The external electrode 20B is in contact with the internal electrodes 12B at the end surface 52. In addition to the end surface 52, the external electrode 20B covers the end portions 40 of the side surfaces 53 and 54, of the lower surface 55, and of the upper surface 56 on the +X side.

Each of the external electrodes 20A and 20B includes a metal underlayer 21 and a plating layer 24. The plating layer 24 covers the metal underlayer 21. On the side surfaces 53 and 54, the lower surface 55, and the upper surface 56, the plating layer 24 is in contact with the element 10 at positions outside the ends of the metal underlayer 21.

The size of the multi-layer ceramic capacitor 100 may be, for example, but not limited to, a length (length in the X direction) of 0.25 mm, a width (width in the Y direction) of 0.125 mm, and a height (height in the Z direction) of 0.125 mm; or a length of 0.4 mm, a width of 0.2 mm, and a height of 0.2 mm; or a length of 0.6 mm, a width of 0.3 mm, and a height of 0.3 mm; or a length of 1.0 mm, a width of 0.5 mm, and a height of 0.5 mm; or a length of 3.2 mm, a width of 1.6 mm, and a height of 1.6 mm; or a length of 4.5 mm, a width of 3.2 mm, and a height of 2.5 mm.

Each of the internal electrodes 12A and 12B contains a base metal, such as nickel (Ni), copper (Cu), and tin (Sn), as a main component. As the internal electrodes 12A and 12B, a noble metal, such as platinum (Pt), palladium (Pd), silver (Ag), or gold (Au), or an alloy containing these, may be used. The thickness of each of the internal electrodes 12A and 12B is, for example, equal to or greater than 0.1 μm and equal to or less than 1 μm.

Each of the dielectric layers 14 is mainly composed of, for example, a ceramic material having a perovskite structure represented by the general formula ABO3. The perovskite structure includes ABO3−α having a stoichiometric composition. For example, the ceramic material can be selected from at least one of barium titanate (BaTiO3), calcium zirconate (CaZrO3), calcium titanate (CaTiO3), strontium titanate (SrTiO3), magnesium titanate (MgTiO3), and Ba1−x−yCaxSryTi1−zZrzO3 (0 ≤ x ≤ 1, 0 ≤ y ≤ 1, 0 ≤ z ≤ 1) forming a perovskite structure. Ba1−x−yCaxSryTi1−zZrzO3 is barium strontium titanate, barium calcium titanate, barium zirconate, barium zirconate titanate, calcium zirconate titanate, or barium calcium zirconate titanate. For example, each of the dielectric layers 14 contains 90 atom% or more of a main component ceramic. The thickness of each of the dielectric layers 14 is, for example, equal to or greater than 0.3 μm and equal to or less than 2 μm.

Additives may be added to the dielectric layers 14. Additives to the dielectric layers 14 include oxides of zirconium (Zr), hafnium (Hf), magnesium (Mg), manganese (Mn), molybdenum (Mo), vanadium (V), chromium (Cr), rare earth elements (Yttrium (Y), samarium (Sm), europium (Eu), gadolinium (Gd), terbium (Tb), dysprosium (Dy), holmium (Ho), erbium (Er), thulium (Tm) and ytterbium (Yb)), or oxides containing cobalt (Co), nickel (Ni), lithium (Li), boron (B), sodium (Na), potassium (K), or silicon (Si), or glass containing cobalt, nickel, lithium, boron, sodium, potassium, or silicon.

The composition of the main ceramic component of the cover dielectric layers 16 may be the same as or different from that of the main ceramic component of the dielectric layers 14.

Each of the metal underlayers 21 contains, as a main component, for example, a metal, such as copper, nickel, aluminum (Al), zinc (Zn), or an alloy of two or more of these (e.g. an alloy of copper and nickel), and also contains a ceramic component, such as a glass component for densifying the metal underlayer 21, a co-material for controlling the sinterability of the external electrodes 20A and 20B, and other components. The glass component includes an oxide of silicon, and may also include an oxide of, for example, barium (Ba), strontium (Sr), calcium (Ca), zinc, aluminum, or boron. The thickness of each of the metal underlayers 21 is, for example, equal to or greater than 3 μm and equal to or less than 50 μm.

Each of the plating layers 24 contains, for example, a metal, such as copper, nickel, aluminum, zinc, or tin, or an alloy of two or more of these metals, as a main component. Each of the plating layers 24 may be a plating layer of a single metal component or a plurality of plating layers of different metal components. Furthermore, a film of a conductive resin such as an epoxy resin or a urethane resin may be formed on the surface of each of the plating layers 24. The thickness of each of the plating layers 24 is, for example, equal to or greater than 5 μm and equal to or less than 15 μm.

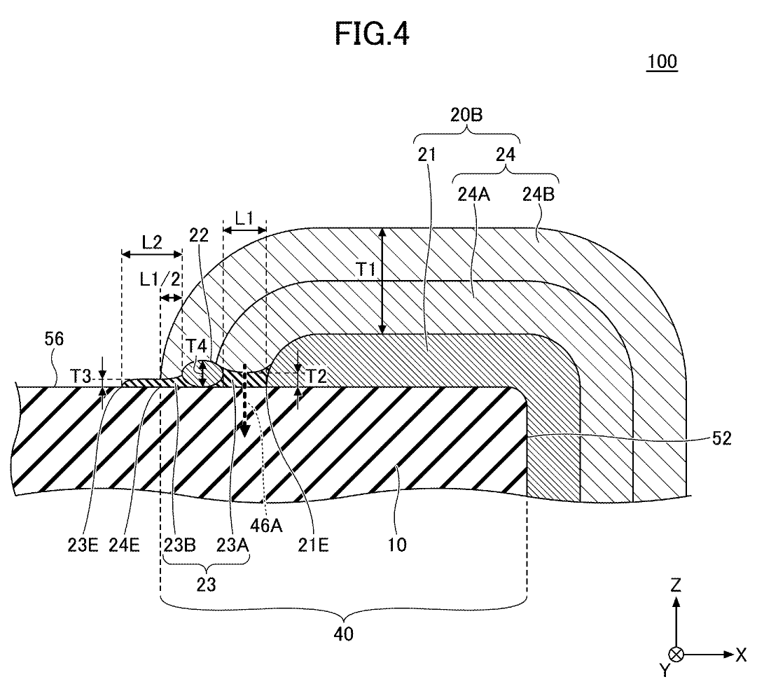

FIG. 4 is an enlarged view of the end portion of the element according to the first embodiment. As illustrated in FIG. 4, metal grains 22 are provided on the element 10 at a position away from an edge 21E of the metal underlayer 21. A glass layer 23A is provided on the element 10 between the edge 21E of the metal underlayer 21 and the metal grains 22. A glass layer 23B is provided on the element 10 on the side of the metal grains 22 facing away from the metal underlayer 21. The glass layer 23 includes glass layers 23A and 23B.

The plating layer 24 is provided on the metal underlayer 21, the glass layer 23, and the metal grains 22. The plating layer 24 has a first layer 24A and a second layer 24B. An edge 24E of the plating layer 24 is located on the −X side relative to the edge 21E of the metal underlayer 21 and the metal grains 22 (i.e., the side facing away from the end surface 52). An edge 23E of the glass layer 23 is located at a position on the −X side relative to the edge 24E.

The metal underlayer 21 and the metal grains 22 contain, for example, copper as a main component. The glass layer 23 contains, for example, silicon oxide as a main component. The first layer 24A contains, for example, nickel as a main component. The second layer 24B contains, for example, tin as a main component. The second layer 24B is a layer to be soldered when the multi-layer ceramic capacitor 100 is solder-mounted. The first layer 24A is a barrier layer between the metal underlayer 21 and the second layer 24B.

### Manufacturing Method of First Embodiment

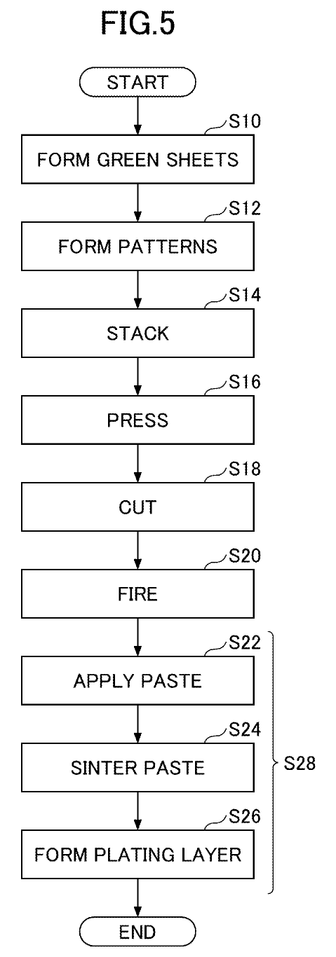

A method of manufacturing the multi-layer ceramic capacitor 100 will be described. FIG. 5 is a flowchart illustrating a method of manufacturing the multi-layer ceramic capacitor according to the first embodiment.

### Green Sheet Formation Step

First, a green sheet is formed (step S10). In step S10, for example, a dielectric material is prepared by adding various additive compounds (sintering aids, etc.) to ceramic powder. A binder such as polyvinyl butyral (PVB) resin, an organic solvent such as ethanol or toluene, and a plasticizer are added to the prepared dielectric material, and a slurry is produced by wet mixing. Using the produced slurry, a green sheet is coated on a substrate by, for example, a die coater method or a doctor blade method. The substrate is, for example, a PET (polyethylene terephthalate) film. Then, the green sheet is dried.

### Pattern Formation Step

Subsequently, metal patterns to be the internal electrodes 12A and 12B are formed on the green sheet (step S12). In step S12, a conductor paste for forming internal electrodes containing an organic binder is printed on the green sheet on the base material by, for example, gravure printing. Thus, a plurality of metal patterns corresponding to the internal electrodes 12A and 12B are formed on the green sheet while being spaced from each other. The conductor paste contains metal powder as a main component, such as nickel powder, a binder, and an organic solvent. Ceramic particles may be added to the conductor paste as a co-material.

### Stacking Step

Subsequently, a plurality of green sheets are stacked (step S14). In step S14, a plurality of green sheets on which metal patterns to be the internal electrodes 12A and 12B are printed are stacked. Green sheets serving as the cover dielectric layers 16 are stacked at opposite ends of the stacked body in the stacking direction.

### Pressing Step

Subsequently, the stacked sheets are pressed together (step S16). In step S16, the plurality of green sheets are laminated by pressing the stacked sheet formed in step S14. As the pressing means, for example, a hydrostatic press is used.

### Cutting Step

Subsequently, the stacked sheet is cut (step S18). In step S18, the stacked sheet is cut in the stacking direction along a predetermined cut line into a plurality of elements 10 by a cutting blade. In each of the elements 10, the internal electrodes 12A are exposed from the end surface 51, and the internal electrodes 12B are exposed from the end surface 52. After step S18, the elements 10 may be polished by a technique such as barrel polishing. The corners of the elements 10 are thereby rounded.

### Firing Step

Subsequently, the elements 10 are fired (step S20). In step S20, the elements 10 are subjected to a debinding treatment in a nitrogen gas atmosphere at 250 °C to 500 °C, and then fired in a reducing atmosphere at 1,300 °C to 1,400 °C for about one hour. Thus, the elements 10 and the particles of the internal electrodes 12A and 12B are sintered.

### External Electrode Formation Step

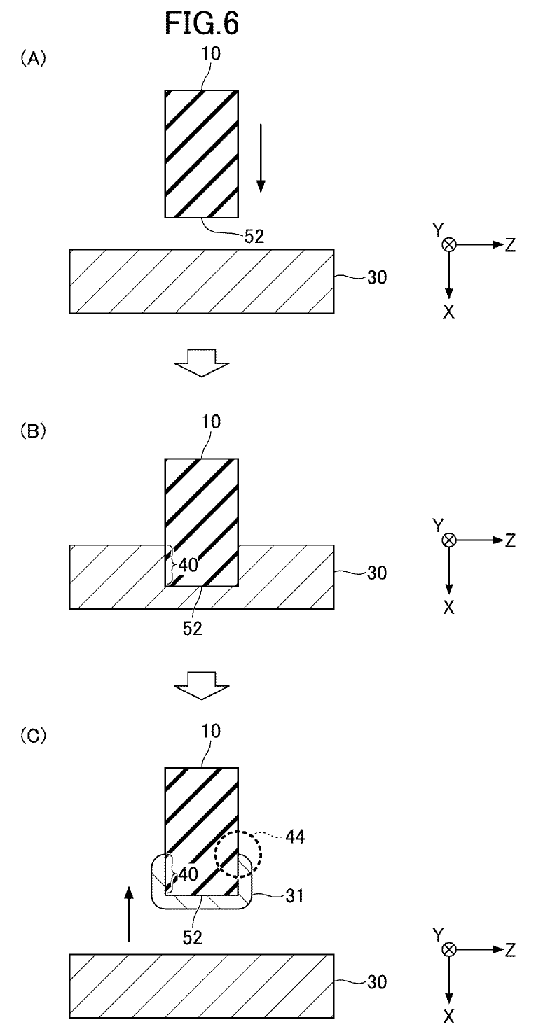

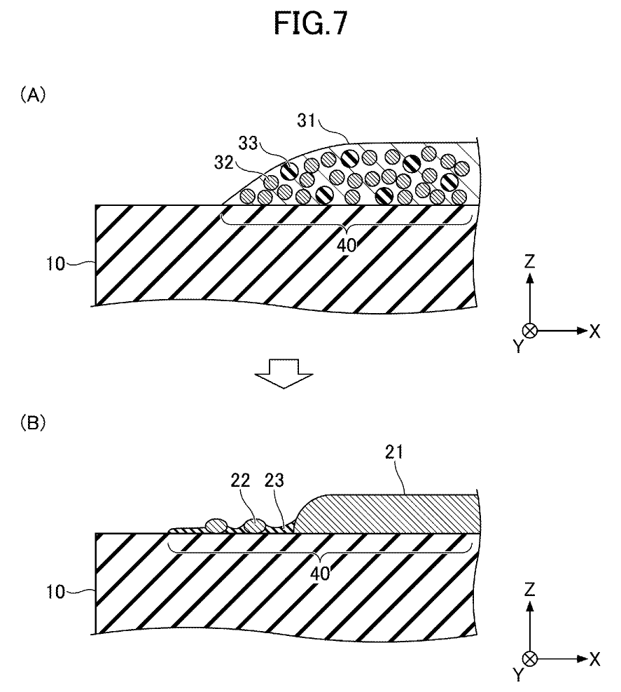

Subsequently, the external electrodes 20A and 20B are formed (step S28). Step S28 includes steps S22, S24, and S26. The diagrams (A) through (C) of FIG. 6 and the diagrams (A) and (B) of FIG. 7 are cross-sectional views illustrating the method of manufacturing a multi-layer ceramic capacitor according to the first embodiment.

First, paste is applied to the element 10 (step S22). Paste is applied to the end portions 40 and the end surface 51 by, for example, a dip method. The paste 30 contains metal particles of a main component such as copper powder, glass particles (glass frit) containing silicon oxide, a binder, and an organic solvent. The glass particles may contain at least one type of metal oxide selected from barium oxide, zinc oxide, calcium oxide, aluminum oxide, magnesium oxide, boron oxide and the like. The content of SiO2 in the glass particles in the paste 30 is, for example, equal to or greater than 40 mol% and equal to or less than 98 mol%. The content of the glass particles in the paste 30 is, for example, equal to or greater than 5 mass% relative to the metal particles.

As illustrated in (A) of FIG. 6, the end surface 52 is positioned facing the paste 30 in a liquid form. The element 10 is brought close to the paste 30 while being moved in the +X direction as indicated by the arrow. As illustrated in (B) of FIG. 6, the end surface 52 and the end portions 40 of the side surfaces 53 and 54, the lower surface 55, and the upper surface 56 are immersed in the paste 30. As illustrated in (C) of FIG. 6, the element 10 is pulled up in the −X direction as indicated by the arrow. As a result, a paste 31 is applied to the end surface 52 and the end portions 40 of the side surfaces 53 and 54, the lower surface 55, and the upper surface 56. The diagram (A) of FIG. 7 is an enlarged view of an area 44 of (C) of FIG. 6. As illustrated in (A) of FIG. 7, the paste 31 contains metal particles 32, glass particles 33, a binder, and an organic solvent. The D50 (cumulative 50 % particle diameter) of the metal particles 32 is, for example, 1 μm or less, and the D50 of the glass particles 33 is, for example, 1 μm or greater and 5 μm or less.

Next, the paste is sintered (step S24). In step S24, the paste is baked in a nitrogen atmosphere at the temperature of 800 °C or higher and 950 °C or lower, which is lower than the firing temperature in step S20. When the metal particles 32 are sintered as illustrated in (A) of FIG. 7, the glass particles 33 gain fluidity and seep out from the tip of the paste 31 due to surface tension. Thus, as illustrated in (B) of FIG. 7, the glass layer 23 is formed beyond the edge 21E of the metal underlayer 21. In order to form the glass layer 23, the content of the glass particles 33 in the paste 30 is preferably 5 mass% or higher relative to the metal particles, the content of silicon oxide in the glass particles 33 is preferably 40 mol% or higher, and the sintering temperature is preferably 800 °C or higher. When the particle diameter of the metal particles 32 is small, for example, when the particle diameter D50 of the metal particles 32 is less than 1 μm, the metal particles 32 remain in the glass layer 23 and become the metal grains 22.

Next, the plating layer 24 is formed (step S26). As illustrated in FIG. 4, the plating layer 24 is formed with the metal underlayer 21 and the metal grains 22 as seeds. When a length L1 between the edge 21E of the metal underlayer 21 and the metal grain 22 is not greater than twice a thickness T1 of the first layer 24A, the first layer 24A grown from the metal grain 22 and the first layer 24A grown from the metal underlayer 21 are connected. Thus, the plating layer 24 is formed on the metal underlayer 21, the metal grains 22, and the glass layer 23.

### Comparative Embodiment 1

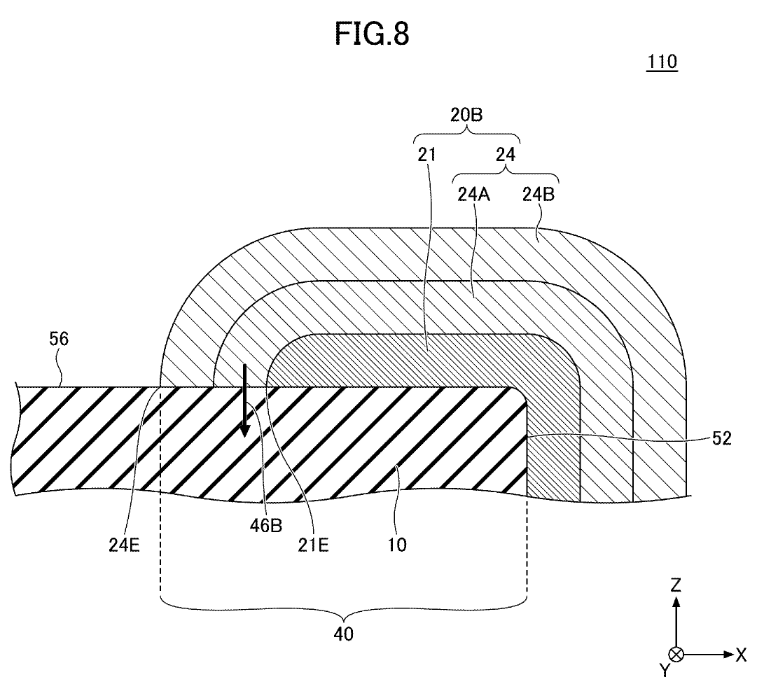

FIG. 8 is an enlarged view of one of the end portions of the element in Comparative Embodiment 1. As illustrated in FIG. 8, the metal grains 22 and the glass layer 23 are not provided in the multi-layer ceramic capacitor 110 of Comparative Embodiment 1. When the content of silicon oxide in the glass particles 33 of the paste 30 is reduced and the sintering temperature of step S24 is set to lower than 800 °C, the glass layer 23 is not easily formed. The plating layer 24 is in contact with the element 10 with no glass layer being interposed therebetween. The plating layer 24 contains a large amount of hydrogen. As illustrated by the solid-line arrow 46B, hydrogen (or hydrogen ions H+) diffuses from the plating layer 24 to the element 10. In particular, when the first layer 24A contains nickel as a main component, since nickel easily stores hydrogen, a large amount of hydrogen is contained in the first layer 24A. The hydrogen reaches the internal electrode 12A or 12B, diffuses through the internal electrodes 12A and 12B, and diffuses into the dielectric layer 14 facing the internal electrodes 12A and 12B. When the dielectric layer 14 is reduced by hydrogen, characteristics deteriorate, for example, leakage current may occur between the internal electrodes 12A and 12B.

### Comparative Embodiment 2

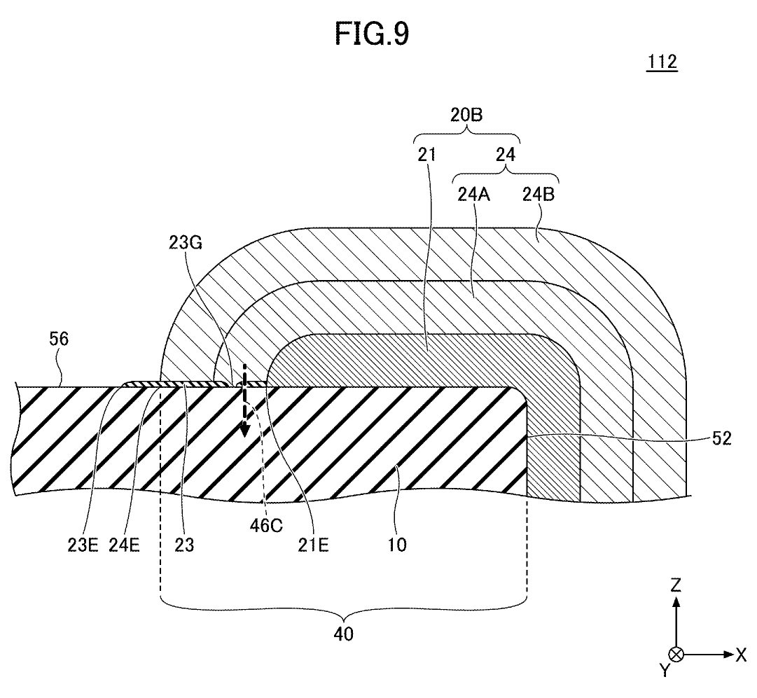

FIG. 9 is an enlarged view of one of the end portions of the element in Comparative Embodiment 2. As illustrated in FIG. 9, in the multi-layer ceramic capacitor 112 of Comparative Embodiment 2, the glass layer 23 is provided on the −X side relative to the edge 21E of the metal underlayer 21. The metal grains 22 are not provided in the glass layer 23. When the content of silicon oxide in the glass particles 33 in the paste 30 is increased and the sintering temperature in step S24 is set to 800 °C or higher, the glass layer 23 is easily formed. When the grain diameter of the metal particles 32 is set to 1 μm or greater, the metal grains 22 are not easily formed. This is considered to be because the metal particles 32 do not appreciably remain in the glass layer 23 when the metal particles 32 are sintered. As illustrated by the broken line arrow 46C, the glass layer 23 makes it difficult for hydrogen to diffuse through the element 10. However, when the glass layer 23 is thin, the glass layer 23 has little effect on suppressing the diffusion of hydrogen. In addition, when the glass layer 23 is thin, an opening 23G through which the glass layer 23 is interrupted may be formed. In the opening 23G, the plating layer 24 comes into contact with the element 10, and hydrogen easily diffuses from the plating layer 24 to the element 10.

### Explanation of First Embodiment

In the first embodiment, in step S22 of FIG. 5 and (A) of FIG. 7, the paste 31 containing the glass particles 33 containing silicon oxide and the metal particles 32 is applied to the end surface 52 and the end portions 40. Sintering the paste 31 in step S24 as illustrated in (B) of FIG. 7 results in the formation of the metal underlayer 21 in the end portions 40, the formation of the metal grains 22 in the end portions 40 at positions away from the edge 21E of the metal underlayer 21 on the side away from the end surface 52, and the formation of the glass layer 23 at a position between the edge 21E and the metal grains 22. In step S26, the plating layer 24 is formed such that the metal underlayer 21, the metal grains 22, and the glass layer 23 are disposed between, and sandwiched by, the plating layer 24 and the element 10. Thus, the thickness of the glass layer 23 between the metal grains 22 and the metal underlayer 21 and in the vicinity of the metal grains 22 can be increased by surface tension. Therefore, diffusion of hydrogen into the element 10 can be suppressed, and deterioration of characteristics, such as an occurrence of leakage current, can be reduced.

In the external electrodes 20A and 20B thus formed, as illustrated in FIG. 4, the metal grains 22 are provided at positions away from the edge 21E of the metal underlayer 21 at the end portion 40 on the side facing away from the end surface 52. The glass layer 23 is provided between the edge 21E and the metal grains 22 and on the side of the metal grains 22 facing away from the end surface 52. The plating layer 24 is provided such that the metal underlayer 21, the metal grains 22, and the glass layer 23 are disposed between, and sandwiched by, the plating layer 24 and the element 10.

In order to form the glass layer 23 in the sintering step in step S24, the composition ratio of silicon oxide in the glass particles 33 in the pastes 30 and 31 is preferably 40 mol% or more, more preferably 50 mol% or more, and most preferably 60 mol% or more. The composition ratio of silicon oxide in the glass layer 23 is preferably 70 mol% or more, more preferably 80 mol% or more, and most preferably 90 mol% or more.

In order to form the glass layer 23, the sintering temperature in step S24 is preferably 800 °C or higher, more preferably 820 °C or higher, and most preferably 850 °C or higher.

In order to form the metal grains 22, the cumulative 50 % particle diameter D50 of the metal particles 32 in the pastes 30 and 31 is preferably 1 μm or less, more preferably 0.9 μm or less, and most preferably 0.8 μm or less. The D50 of the metal particles 32 in the pastes 30 and 31 may be 0.1 μm or greater.

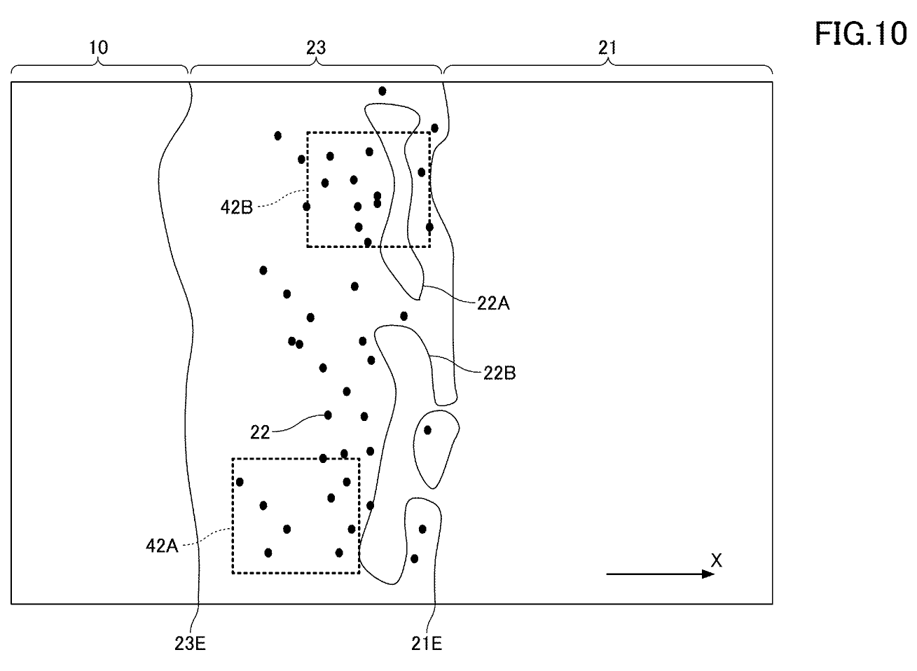

FIG. 10 is a schematic plan view of the vicinity of the edge of the metal underlayer at one of the end portions of the element in the first embodiment. FIG. 10 is a schematic view of the element 10 seen from the +Z direction after step S24 is performed. As illustrated in FIG. 10, in addition to the metal grains 22, metal pieces 22A and 22B larger than the metal grains 22 may be provided in the −X direction relative to the metal underlayer 21 (the side away from the end surface). The width of each of the metal pieces 22A and 22B may exceed 5 μm, for example. In this case, the edge 21 of the metal underlayer 21 is defined by whether or not the edge 21E is connected to the metal underlayer 21. The metal piece 22A is not connected to the metal underlayer 21. The metal piece 22B is connected to the metal underlayer 21.

In this case, the edge of the metal piece 22B is considered to be the edge 21E of the metal underlayer 21. The edge of the metal piece 22A is not considered to be the edge 21E of the metal underlayer 21. The metal grains 22 and the metal piece 22A are referred to as “metal portions” hereinafter. The metal piece 22A is not always included in the metal portions, and the metal portions may be composed of the metal grains 22 only.

When the density of the metal grains 22 on the surface of the element 10 is small, the region where the glass layer 23 becomes thick is limited. From this viewpoint, the number of the metal grains 22 in ranges 42A and 42B of 10 μm ×10 μm , the ranges being on the −X side and in contact with the edge 21E, is preferably 5 or more, more preferably 10 or more, and most preferably 20 or more. The number of the metal grains 22 included in a range 42 may be 100 or less. In order to make the glass layer 23 thick, it is preferable that the grain diameter of the metal grains 22 be large. From this viewpoint, the grain diameter of the metal grains 22 for which the number thereof included in the range 42 is calculated is preferably 0.1 μm or greater, and more preferably 0.5 μm or greater. The grain diameter of the metal grains 22 for which the number thereof included in the range 42 is calculated may be 5 μm or less.

In FIG. 4, if the length L1 between the edge 21E and the metal grain 22 is too large, it is difficult to increase a thickness T2 of the glass layer between the edge 21E and the metal grain 22. From this viewpoint, the length L1 is preferably equal to or less than the thickness T1 of the plating layer 24, and more preferably equal to or less than 0.8 times the thickness T1. The length L1 may be equal to or greater than 0.1 times the thickness T1.

The thickness T2 of the glass layer 23A is greater than a thickness T3 of the glass layer 23B. Thus, the thickness of the glass layer 23 between the plating layer 24 and the element 10 can be increased. The thickness T2 is the minimum thickness of the glass layer 23A provided between the edge 21E and the metal grains 22. The thickness T3 is the thickness of the glass layer 23A at a position 1/2 of the length L1 on the −X side of the metal grains 22. The thickness T3 is preferably 0.8 times or less, and more preferably 0.5 times or less of the thickness T2.

From the viewpoint of increasing the thickness of the glass layer 23 between the plating layer 24 and the element 10, the thickness T2 is preferably 0.5 times or more, and more preferably 0.7 times or more of a maximum thickness T4 of the metal grains 22. The thickness T2 may be equal to or less than the thickness T4. The length L1 and the thicknesses T1 through T4 can be calculated from at least one electron microscope image.

The metal underlayer 21 and the metal grains 22 may contain copper as a main component. This facilitates the formation of the metal grains 22 and the glass layer 23. The first layer 24A of the plating layer 24 closest to the metal underlayer 21 may contain nickel as a main component. With inclusion of nickel, hydrogen is easily stored. As illustrated in FIG. 4, the thickness of the glass layer 23 between the first layer 24A containing nickel as a main component and the element can be increased.

In the metal underlayer 21, the composition at the end portions 40 and the composition at the end surfaces 51 and 52 may be differentiated. For example, the metal underlayer 21 at the end portions 40 may be made of a material which easily forms the metal grains 22 and the glass layer 23, and the metal underlayer 21 at the end surfaces 51 and 52 may be made of a material which lowers resistance.

### EXAMPLES

Example 1 corresponding to the first embodiment, Comparative Example 1 corresponding to Comparative Example 1, and Comparative Example 2 corresponding to Comparative Example 2 were prepared.

In Example 1, copper was used as the main component of the metal particles 32 in the paste 30. The D50 of the metal particles 32 was set to less than 1 μm. The D50 of the glass particles 33 was set to about 3 μm. The composition ratio of silicon oxide in the glass particles 33 was set to 50 mol%. The sintering temperature in step S24 was set to 850 °C.

In Comparative Example 1, copper was used as the main component of the metal particles 32 in the paste 30. The D50 of the metal particles 32 was set to about 3 μm. The D50 of the glass particles 33 was set to about 3 μm. The content of silicon oxide in the glass particles 33 was set to 10 mol% or less. The sintering temperature in step S24 was set to 850 °C.

In Comparative Example 2, copper was used as the main component of the metal particles 32 in the paste 30. The D50 of the metal particles 32 was set to about 3 μm. The D50 of the glass particles 33 was set to about 3 μm. The content of silicon oxide in the glass particles 33 was set to 50 mol%. The sintering temperature in step S24 was set to 850 °C.

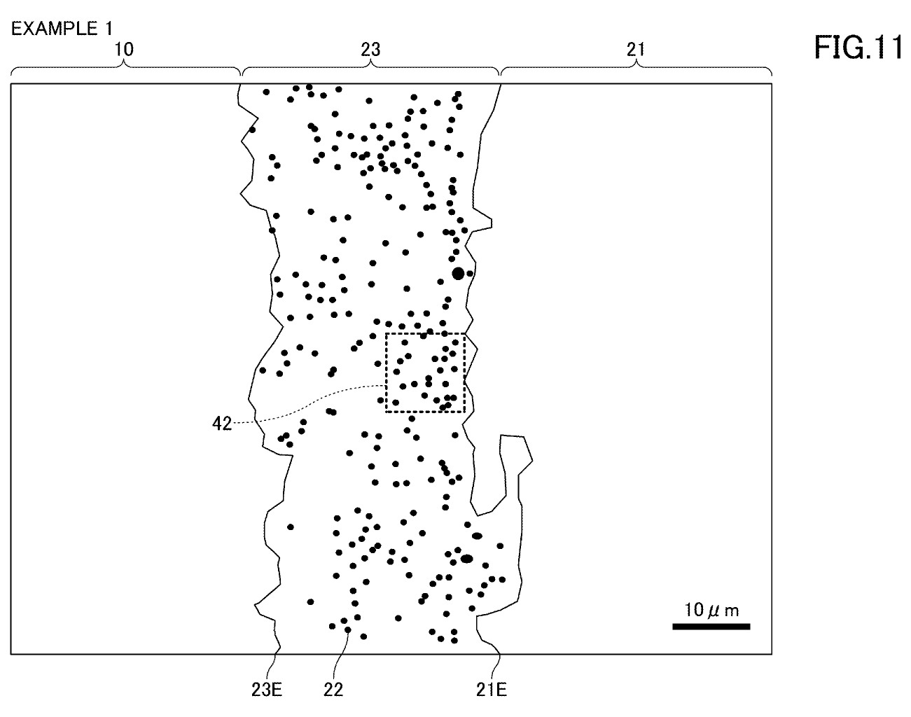

FIG. 11 is a schematic plan view of the vicinity of the edge of the metal underlayer at one of the end portions of the element in Example 1, and is a schematic view when the element 10 was observed with a metal microscope from the +Z direction after step S24 was performed. As illustrated in FIG. 8, the edge 21E of the metal underlayer 21 and the edge 23E of the glass layer 23 had large irregularities. The metal grains 22 separated from the metal underlayer 21 were scattered in the glass layer 23. The size (grain diameter) of the metal grains 22 was about 1 μm. The number of the metal grains 22 in the range 42 of 10 μm × 10 μm was 5 or more, the range being on the −X side and in contact with the edge 21E of the metal underlayer 21.

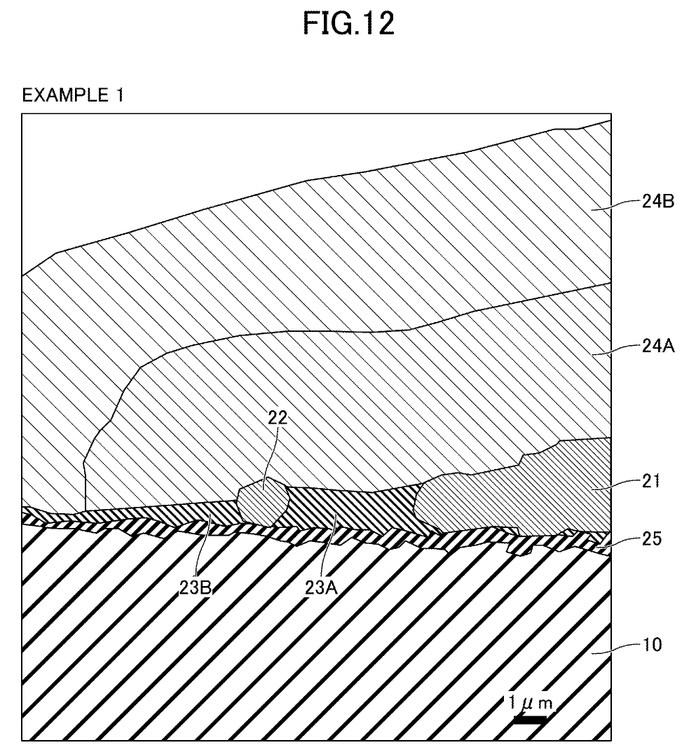

FIG. 12 is a schematic cross-sectional view of the vicinity of the edge of the metal underlayer at one of the end portions of the element in Example 1, and a schematic cross-sectional SEM image after step S26 was performed. As illustrated in FIG. 12, a crystal layer 25 was formed on the element 10. The crystal layer 25 was an oxide containing silicon, barium and titanium, and was an oxide layer obtained by reacting silicon oxide with barium and titanium in the element. The metal underlayer 21, the metal grains 22, and the glass layers 23A and 23B were formed on the crystal layer 25. The first layer 24A and the second layer 24B were formed on the metal underlayer 21, the metal grains 22, and the glass layers 23A and 23B. The first layer 24A contained nickel as a main component and the second layer 24B contained tin as a main component.

The grain size of the metal grains 22 was 1 μm or greater and the thickness of the glass layer 23A was 1 μm or greater. The thickness of the glass layer 23B was smaller than the thickness of the glass layer 23A and was about 1 μm to 0.5 μm.

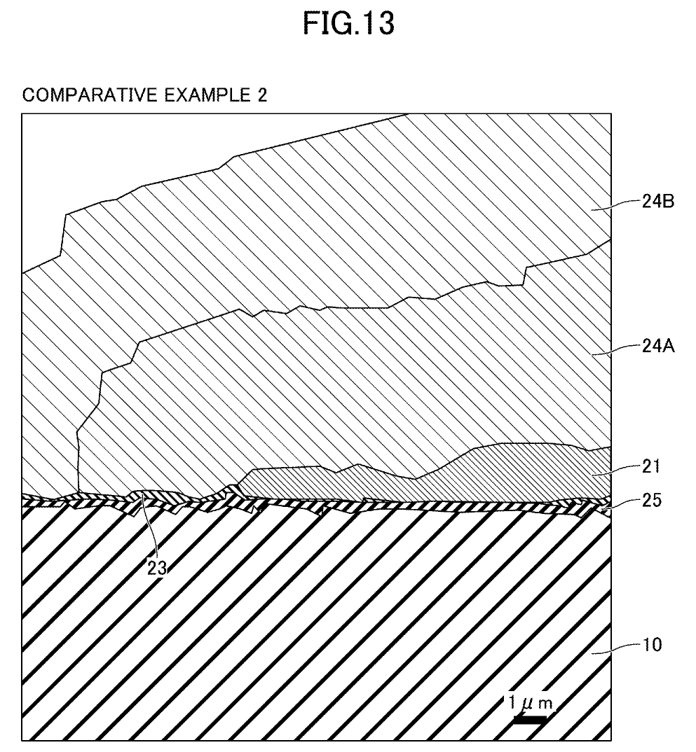

FIG. 13 is a schematic cross-sectional view of the vicinity of the edge of the metal underlayer at one of the end portions of the element in Comparative Example 2, and a schematic cross-sectional SEM image after step S26 was performed. As illustrated in FIG. 13, in Comparative Example 2, although the glass layer 23 was formed between the plating layer 24 and the element 10, the glass layer 23 was thinner than that in Example 1 illustrated in FIG. 12.

As illustrated in FIGS. 12 and 13, in Example 1, the thickness of the glass layer 23 can be increased by providing the metal grains 22. Thus, diffusion of hydrogen in the plating layer 24 into the element 10 can be suppressed. Since the glass layer 23 is thick, the opening 23G of the glass layer 23 as in Comparative Example 2 of FIG. 9 is not easily formed, and diffusion of hydrogen from the plating layer 24 to the element 10 through the opening 23G can be suppressed.

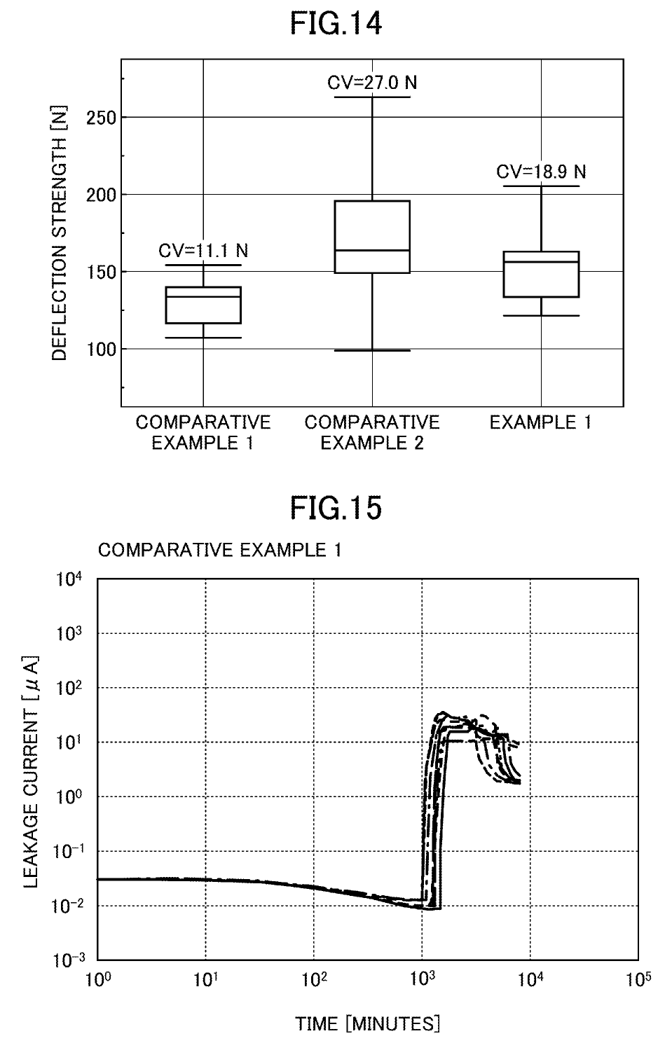

FIG. 14 is a diagram illustrating the deflection strengths in Comparative Example 1, Comparative Example 2, and Example 1. The deflection strengths were measured by performing a three-point bending test on a 3216 element (having dimensions of 3.2 mm in length, 1.6 mm in width, and 1.6 mm in height). The deflection strengths of ten samples in Comparative Examples 12 and Example 1 were measured, respectively, to form a box plot. The coefficient of variation CV of the deflection strengths is written on the box.

As illustrated in FIG. 14, the median values of the deflection strengths in Comparative Example 2 and Example 1 were larger than those in Comparative Example 1. The median values of the deflection strengths in Comparative Example 2 and Example 1 were substantially the same. The coefficient of variation CV of the deflection strengths in Comparative Example 2 was as large as 27.0 N. The coefficient of variation CV of the deflection strengths in Example 1 was 18.9 N, which was smaller than that in Comparative Example 2.

As in Comparative Example 2 and Example 1, the deflection strength can be improved by providing the glass layer 23. This is considered to be because the element 10 was reinforced by the glass layer 23. The variation of the deflection strength was smaller in Example 1 than in Comparative Example 2. This is considered to be because the variation of the thickness of the glass layer 23 was reduced by providing the metal grains 22.

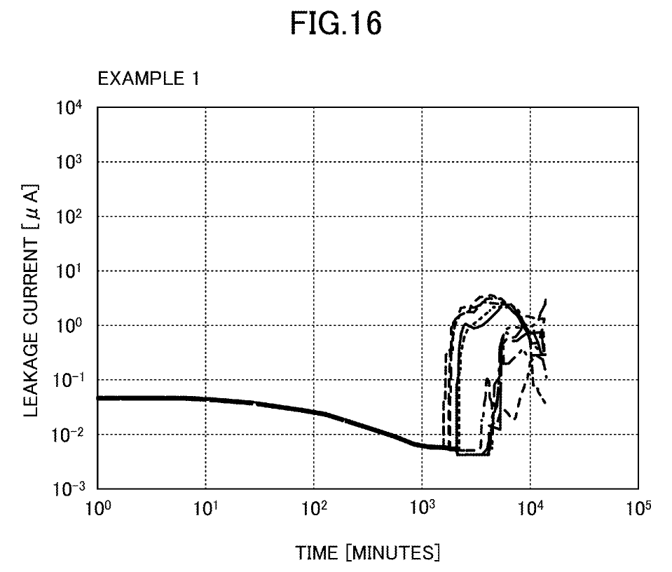

Acceleration tests were performed on Comparative Example 1 and Example 1 under conditions where the environmental temperature was 150 °C and the electric field strength in the dielectric layer 14 was 5 V/μm. FIG. 15 is a diagram illustrating the leakage current with respect to time in Comparative Example 1. FIG. 16 is a diagram illustrating the leakage current with respect to time in Example 1. A plurality of lines in FIGS. 15 and 16 correspond to a plurality of samples.

As illustrated in FIG. 15, at the beginning of the acceleration test, the leakage current was 10-1 μA or less, which is very small. In Comparative Example 1, after 1×103 minutes elapsed, some samples whose leakage current rapidly increases appeared. After 2×103 minutes elapsed, the leakage current of most samples rapidly increased. As illustrated in FIG. 16, in Example 1, at the beginning of the acceleration test, the leakage current was 10-1 μA or less, which is similar to Comparative Example 1. After 2×103 minutes elapsed, a sample in which the leakage current rapidly increases appeared.

The time required for leakage current to rapidly increase was 1×103 minutes in Comparative Example 1 and 2.3×103 minutes in Example 1. Thus, the time for deterioration of characteristics was 2.3 times longer in Example 1 than in Comparative Example 1. This is considered to be because diffusion of hydrogen into the element 10 was suppressed by the glass layer 23.

The composition ratio of silicon oxide is measured, for example, using a STEM (scanning transmission electron microscope)-EDS (energy dispersive X-ray spectroscopy) method. The glass layer 23 or the glass particles 33 are irradiated with an electron beam, and the molar ratio of SiO2 in the glass layer 23 or the glass particles 33 is calculated from the peaks of silicon and metal elements in the glass layer 23 or the glass particles 33 to obtain a silicon oxide composition. The silicon oxide composition may be measured at any part of the corresponding layer. When a certain member has a certain element or molecule as a main component, it suffices that the certain element or molecule is contained in the certain member to an extent that the effect of the embodiment is obtained, and the concentration of the certain element or molecule in the certain member is, for example, 50 mol% or more, 80 mol% or more, or 90 mol% or more.

Although the embodiments have been described in detail above, the present disclosure is not limited to a particular embodiment, and various modifications and modifications are possible within the scope described in the appended claims.

The embodiments disclosed above include, for example, the following aspects.

### <1>

A multi-layer ceramic electronic component, including:
an element in which a plurality of internal electrodes and a plurality of dielectric layers containing a ceramic as a main component are alternately stacked, the element having end surfaces opposite each other;
a metal underlayer provided at an end portion of a surface adjacent to the end surfaces, the end portion being closer to one of the end surfaces, the metal underlayer being in contact with one or more of the plurality of internal electrodes that are exposed on at least one of the end surfaces;
metal portions provided at positions away from the metal underlayer and that are in contact with the surface adjacent to the end surfaces;
a glass layer provided between an edge of the metal underlayer and the metal portions and on a side of the metal portions facing away from a corresponding end surface of the end surfaces; and
a plating layer provided on the end portion such that the metal underlayer, the metal portions, and the glass layer are disposed between, and sandwiched by, the plating layer and the element, the plating layer and the metal underlayer forming an external electrode.

### <2>

The multi-layer ceramic electronic component according to <1>, wherein the glass layer contains silicon oxide.

### <3>

The multi-layer ceramic electronic component according to <2>, wherein a composition ratio of the silicon oxide in the glass layer is 70 mol% or more.

### <4>

The multi-layer ceramic electronic component according to any one of <1> to <3>, wherein the metal portions are composed of metal grains.

### <5>

The multi-layer ceramic electronic component according to any one of <1> to <4>, wherein a number of the metal portions in a range of 10 μm × 10 μm is 5 or more, the range being on a side of the metal portions facing away from the corresponding end surface and being in contact with the edge of the metal underlayer.

### <6>

The multi-layer ceramic electronic component according to any one of <1> to <5>, wherein a length between the edge of the metal underlayer and the metal portions is smaller than a thickness of the plating layer.

### <7>

The multi-layer ceramic electronic component according to any one of <1> to <6>, wherein a minimum thickness of the glass layer provided between the edge of the metal underlayer and the metal portions is larger than a thickness of the glass layer at a position halfway between the edge of the metal underlayer and a metal portion of the metal portions, the position being on the side of the metal portions facing away from the corresponding end surface.

### <8>

The multi-layer ceramic electronic component according to any one of <1> to <7>, wherein a minimum thickness of the glass layer provided between the edge of the metal underlayer and the metal portions is 1/2 or more of a maximum thickness of a metal portion of the metal portions.

### <9>

The multi-layer ceramic electronic component according to any one of <1> to <8>, wherein the metal underlayer and the metal portions contain copper as a main component.

### <10>

The multi-layer ceramic electronic component according to any one of <1> to <9>, wherein a sub-layer of the plating layer closest to the metal underlayer contains nickel as a main component.

### <11>

A method of manufacturing a multi-layer ceramic electronic component, the method including:
preparing an element in which a plurality of internal electrodes and a plurality of dielectric layers containing a ceramic as a main component are alternately stacked, the element having end surfaces opposite each other;
applying paste containing glass particles containing silicon oxide and metal particles to the end surfaces and an end portion of a surface adjacent to the end surfaces;
sintering the paste to form
   a metal underlayer provided at the end portion and being in contact with one or more of the plurality of internal electrodes that are exposed on at least one of the end surfaces,
   metal portions provided at positions away from the metal underlayer and that are in contact with the surface adjacent to the end surfaces, and
   a glass layer provided between an edge of the metal underlayer and the metal portions and on a side of the metal portions facing away from a corresponding end surface of the end surfaces; and
forming a plating layer which is provided at the end portion such that the metal underlayer, the metal portions, and the glass layer are disposed between, and sandwiched by, the plating layer and the element, the plating layer and the metal underlayer forming an external electrode.

### <12>

The method of manufacturing a multi-layer ceramic electronic component according to <11>, wherein a cumulative 50 % particle diameter of the metal particles is 1 μm or less.

### <13>

The method of manufacturing a multi-layer ceramic electronic component according to <11> or <12>, wherein a composition ratio of silicon oxide in the glass particles is 40 mol% or more.

### <14>

The method of manufacturing a multi-layer ceramic electronic component according to any one of <11> to <13>, wherein a firing temperature of the paste is 800 °C or higher.

What is claimed is:

1. A multi-layer ceramic electronic component, comprising:
an element in which a plurality of internal electrodes and a plurality of dielectric layers containing a ceramic as a main component are alternately stacked, the element having end surfaces opposite each other;
a metal underlayer provided at an end portion of a surface adjacent to the end surfaces, the end portion being closer to one of the end surfaces, the metal underlayer being in contact with one or more of the plurality of internal electrodes that are exposed on at least one of the end surfaces;
metal portions provided at positions away from the metal underlayer and that are in contact with the surface adjacent to the end surfaces;
a glass layer provided between an edge of the metal underlayer and the metal portions and on a side of the metal portions facing away from a corresponding end surface of the end surfaces; and
a plating layer provided on the end portion such that the metal underlayer, the metal portions, and the glass layer are disposed between, and sandwiched by, the plating layer and the element, the plating layer and the metal underlayer forming an external electrode.

2. The multi-layer ceramic electronic component according to claim 1, wherein
the glass layer contains silicon oxide.

3. The multi-layer ceramic electronic component according to claim 2, wherein
a composition ratio of the silicon oxide in the glass layer is 70 mol% or more.

4. The multi-layer ceramic electronic component according to claim 1, wherein
the metal portions are composed of metal grains.

5. The multi-layer ceramic electronic component according to claim 1, wherein
a number of the metal portions in a range of 10 μm × 10 μm is 5 or more, the range being on a side of the metal portions facing away from the corresponding end surface and being in contact with the edge of the metal underlayer.

6. The multi-layer ceramic electronic component according to claim 1, wherein
a length between the edge of the metal underlayer and the metal portions is smaller than a thickness of the plating layer.

7. The multi-layer ceramic electronic component according to claim 1, wherein
a minimum thickness of the glass layer provided between the edge of the metal underlayer and the metal portions is larger than a thickness of the glass layer at a position halfway between the edge of the metal underlayer and a metal portion of the metal portions, the position being on the side of the metal portions facing away from the corresponding end surface.

8. The multi-layer ceramic electronic component according to claim 1, wherein
a minimum thickness of the glass layer provided between the edge of the metal underlayer and the metal portions is 1/2 or more of a maximum thickness of a metal portion of the metal portions.

9. The multi-layer ceramic electronic component according to claim 1, wherein
the metal underlayer and the metal portions contain copper as a main component.

10. The multi-layer ceramic electronic component according to claim 1, wherein
a sub-layer of the plating layer closest to the metal underlayer contains nickel as a main component.

11. A method of manufacturing a multi-layer ceramic electronic component, the method comprising:
preparing an element in which a plurality of internal electrodes and a plurality of dielectric layers containing a ceramic as a main component are alternately stacked, the element having end surfaces opposite each other;
applying paste containing glass particles containing silicon oxide and metal particles to the end surfaces and an end portion of a surface adjacent to the end surfaces;
sintering the paste to form
a metal underlayer provided at the end portion and being in contact with one or more of the plurality of internal electrodes that are exposed on at least one of the end surfaces,
metal portions provided at positions away from the metal underlayer and that are in contact with the surface adjacent to the end surfaces, and
a glass layer provided between an edge of the metal underlayer and the metal portions and on a side of the metal portions facing away from a corresponding end surface of the end surfaces; and
forming a plating layer which is provided at the end portion such that the metal underlayer, the metal portions, and the glass layer are disposed between, and sandwiched by, the plating layer and the element, the plating layer and the metal underlayer forming an external electrode.

12. The method of manufacturing a multi-layer ceramic electronic component according to claim 11, wherein
a cumulative 50 % particle diameter of the metal particles is 1 μm or less.

13. The method of manufacturing a multi-layer ceramic electronic component according to claim 11, wherein
a composition ratio of silicon oxide in the glass particles is 40 mol% or more.

14. The method of manufacturing a multi-layer ceramic electronic component according to claim 11, wherein
a firing temperature of the paste is 800 °C or higher.
